(19) United States
(12) Patent Application Publication
(10) Pub. No.: US 2024/0385594 A1
(43) Pub. Date: Nov. 21, 2024

(54) METHODS AND INTERNET OF THINGS SYSTEMS FOR CENTRALIZED HEATING GAS SUPERVISION BASED ON SUPERVISION PLATFORMS

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Bin LIU, Chengdu (CN); Lilong SU, Chengdu (CN)

(73) Assignee: CHENGDU QINCHUAN IOT TECHNOLOGY CO., LTD., Chengdu (CN)

(21) Appl. No.: 18/786,623

(22) Filed: Jul. 29, 2024

(30) Foreign Application Priority Data
May 28, 2024 (CN) 202410670108.5

(51) Int. Cl. G05B 19/4155

(52) U.S. Cl. CPC G05B 19/4155; G05B 2219/41108

(57) ABSTRACT

Embodiments of the present disclosure provide a method and an Internet of Things system for centralized heating gas supervision based on a supervision platform. The method includes obtaining an indoor environmental feature of each sub-region in a target region and gas consumption data of a heat supply source in the target region by a gas company sensor network plat form, the indoor environmental feature and the gas consumption data being collected by a smart gas device object platform; determining whether heating data in the target region meets a preset condition based on the indoor environmental feature of each sub-region and the gas consumption data; generating an early warning message in response to determining that the heating data does not meet the preset condition, and sending the early warning message to a gas user platform by a gas user service platform.

### CROSS-REFERENCE TO RELATED APPLICATION

The present disclosure claims priority of Chinese Patent Application No. 202410670108.5, filed on May 28, 2024, the entire contents of which are incorporated herein by reference.

### TECHNICAL FIELD

The present disclosure relates to the field of gas supervision, and in particular, to a method and an Internet of Things (IoT) system for centralized heating gas supervision based on a supervision platform.

### BACKGROUND

Heating is a common demand in winter, but the current gas heating process lacks effective regulation. The heating is too dispersed in time and space, preventing efficient utilization of heating resources and leading to resource waste. Heating pipelines or other supporting facilities are often installed in hidden locations, making it difficult for users to promptly detect equipment issues, such as faulty water supply pipelines or dirt accumulation, which can result in heating abnormalities and faults in the heat supply source. Consequently, this leads to inefficient heating and the heating effect not meeting user expectations. Additionally, during use, users may inadvertently cause heating faults by obstructing the heat measurement source, which can pose safety risks.

Therefore, an Internet of Things (IoT) system and a method for centralized heating gas supervision based on a supervisory platform are needed.

### SUMMARY

One or more embodiments of the present disclosure provide a method for centralized heating gas supervision based on a supervision platform. The method is executed by a gas company management platform, comprising: obtaining an indoor environmental feature of each sub-region in a target region and gas consumption data of a heat supply source in the target region by a gas company sensor network platform, the indoor environmental feature and the gas consumption data being collected by a smart gas device object platform; determining whether heating data in the target region meets a preset condition based on the indoor environmental feature of each sub-region and the gas consumption data; generating an early warning message in response to determining that the heating data does not meet the preset condition, and sending the early warning message to a gas user platform by a gas user service platform; determining a gas supply capacity of the heat supply source based on a regional gas load of the target region; determining a heat supply capacity of the heat supply source based on the gas supply capacity; determining a heat supply parameter of a heating device in the sub-region based on the heat supply capacity and the indoor environmental feature of the sub-region; generating a heat supply instruction based on the heat supply parameter, transmitting the heat supply instruction to the smart gas device object platform by the gas company sensor network platform, and sending the heat supply instruction to the heating device in each sub-region by the smart gas device object platform.

One of the embodiments of the present disclosure provides an Internet of Things (IoT) system for centralized heating gas supervision based on a supervision platform. The IoT system includes a smart gas government supervision and management platform, a smart gas government supervision sensor network platform, a smart gas government supervision object platform, a gas company sensor network platform, a smart gas device object platform, a gas user platform, and a gas user service platform. The smart gas government supervision object platform includes a gas company management platform, the gas company management platform is configured to obtain an indoor environmental feature of each sub-region in a target region and gas consumption data of a heat supply source in the target region by the gas company sensor network platform, the indoor environmental feature and the gas consumption data being collected by the smart gas device object platform; determine whether heating data in the target region meets a preset condition based on the indoor environmental feature of each sub-region and the gas consumption data; generate an early warning message in response to determining that the heating data does not meet the preset condition, and send the early warning message to the gas user platform by the gas user service platform; determine a gas supply capacity of the heat supply source based on a regional gas load of the target region; determine a heat supply capacity of the heat supply source based on the gas supply capacity; determine a heat supply parameter of a heating device in the sub-region based on the heat supply capacity and the indoor environmental feature of the sub-region; generate a heat supply instruction based on the heat supply parameter, transmit the heat supply instruction to the smart gas device object platform by the gas company sensor network platform, and send the heat supply instruction to the heating device in each sub-region by the smart gas device object platform.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings:

FIG. 1 is a schematic diagram illustrating an exemplary platform structure of an Internet of Things (IoT) system for centralized heating gas supervision based on a supervision platform according to some embodiments of the present disclosure;

FIG. 2 is a flow chart illustrating a method for centralized heating gas supervision based on a supervision platform according to some embodiments of the present disclosure;

FIG. 3 is a schematic diagram illustrating determining a heat supply parameter according to some embodiments of the present disclosure;

FIG. 4 is a schematic diagram illustrating determining whether heating data meets a preset condition according to some embodiments of the present disclosure;

FIG. 5 is another schematic diagram illustrating determining whether the heating data meets the preset condition according to some embodiments of the present disclosure; and

FIG. 6 is a schematic diagram illustrating a fault prediction model according to some embodiments of the present disclosure.

### DETAILED DESCRIPTION

In order to more clearly illustrate the technical solutions of the embodiments of the present disclosure, the accompanying drawings to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that as used herein, the terms “system”, “device”, “unit” and/or “module” are used herein as a way to distinguish between different components, elements, parts, sections, or assemblies at different levels. However, the words may be replaced by other expressions if other words accomplish the same purpose.

As shown in the present disclosure and in the claims, unless the context clearly suggests an exception, the words “a”, “an” and/or “the” do not refer specifically to the singular and may include the plural. Generally, the terms “including” and “comprising” suggest only the inclusion of clearly identified steps and elements, and these steps and elements do not constitute an exclusive list, and the method or apparatus may also include other steps or elements.

Flowcharts are used in the present disclosure to illustrate operations performed by a system in accordance with embodiments of the present disclosure. It should be appreciated that the preceding or following operations are not necessarily performed in an exact sequence. Instead, steps may be processed in reverse order or simultaneously. Also, it is possible to add other operations to these processes or remove a step or step from them.

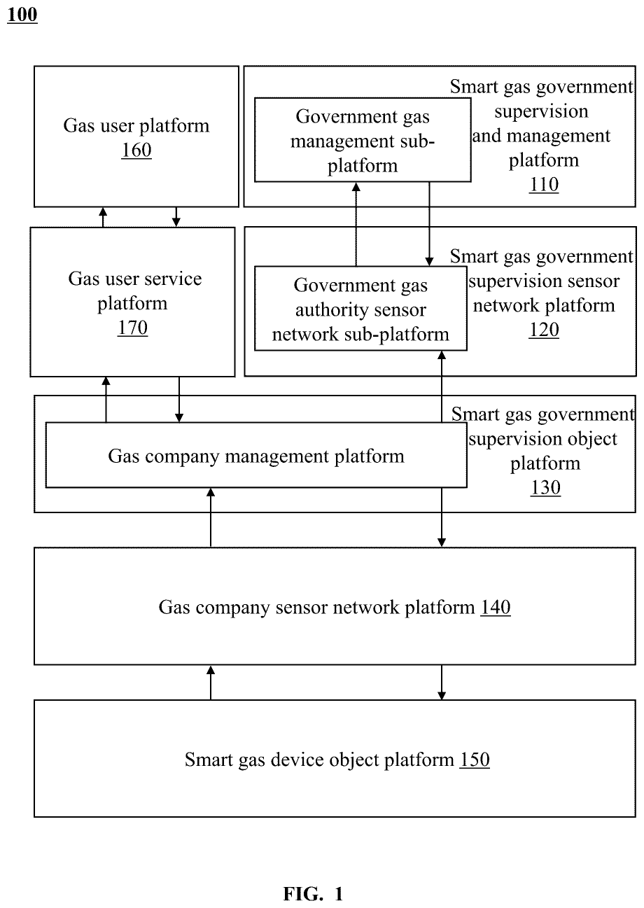

FIG. 1 is a schematic diagram illustrating an exemplary platform structure of an Internet of Things (IoT) system for centralized heating gas supervision based on a supervision platform according to some embodiments of the present disclosure.

As shown in FIG. 1, a system for centralized heating gas supervision 100 (hereinafter referred to as a supervision system 100) based on a supervision platform may include a smart gas government supervision and management platform 110, a smart gas government supervision sensor network platform 120, a smart gas government supervision object platform 130, a gas company sensor network platform 140, a smart gas device object platform 150, a gas user platform 160, and a gas user service platform 170.

The smart gas government supervision and management platform 110 is a comprehensive management platform for a government to manage information. In some embodiments, the smart gas government supervision and management platform may be configured for data processing and storage in the supervision system 100.

In some embodiments, the smart gas government supervision and management platform may include a government gas management sub-platform. The government gas management sub-platform is a sub-platform for the government to manage gas usage, and in some embodiments, the government gas management sub-platform may interact with the smart gas government supervision sensor network platform.

The smart gas government supervision sensor network platform 120 is a platform for integrated management of government sensing information. In some embodiments, the smart gas government supervision sensor network may include a government gas authority sensor network sub-platform.

The government gas authority sensor network sub-platform is a sub-platform for integrated management of sensing information of a government gas department. In some embodiments, the government gas authority sensor network sub-platform may interact with the smart gas government supervision object platform. For example, the smart gas government supervision sensor network platform may send mobility data of residents in a target region to the smart gas government supervision object platform.

The smart gas government supervision object platform 130 is a platform for generating government supervision information and executing control information. In some embodiments, the smart gas government supervision object platform may include a gas company management platform.

The gas company management platform is used to coordinate and harmonize the linkage and collaboration between functional platforms, and aggregates all information of the IoT system, and serves as a platform for providing sensing management and control management functions for the IoT system.

In some embodiments, the gas company management platform may interact with the smart gas government supervision sensor network platform, the gas company sensor network platform, and the gas user service platform, respectively. For example, the gas company management platform may obtain an indoor environmental feature of a sub-region from the gas company sensor network platform. As another example, the gas company management platform may generate an early warning message and send the early warning message to the gas user service platform. As another example, the gas company management platform may obtain mobility data of residents in a target region from the gas government safety supervision sensor network platform.

The gas company sensor network platform 140 refers to a platform for integrated management of sensing information of a gas company. In some embodiments, the gas company sensor network platform may be configured as a communication network, gateway, or the like.

In some embodiments, the gas company sensor network platform is in bi-directional communication with the smart gas device object platform to receive data obtained by the smart gas device object platform.

The smart gas device object platform 150 is a functional platform for generating sensing information and executing control information. In some embodiments, the smart gas device object platform may interact with the gas company sensor network platform.

The gas user platform 160 is a gas user-oriented platform. In some embodiments, the gas user platform may interact with the gas user service platform. For example, the gas user service platform may send the early warning message to the gas user platform.

The gas user service platform 170 is a platform used to provide information related to an operation of a gas pipeline network.

In some embodiments, the gas user service platform may interact with the gas company management platform. For example, the gas user service platform may obtain the early warning message from the gas company management platform.

In some embodiments, platforms in the supervision system 100 may be divided into a smart gas primary network and a smart gas secondary network. The smart gas primary network refers to a network in which a government user regulates the operation of the gas pipeline network, and the smart gas secondary network includes a network in which the gas pipeline network operates. In some embodiments, a same platform in the supervision system 100 may assume different roles in the smart gas primary network and the smart gas secondary network.

In some embodiments, the smart gas primary network may include a smart gas primary network management platform, a smart gas primary network sensor network platform, and a smart gas primary network object platform. The smart gas primary network management platform may include the smart gas government supervision and management platform, the smart gas primary network sensor network platform may include the smart gas government supervision sensor network platform, and the smart gas primary network object platform may include the gas company management platform. As another example, the smart gas secondary network may include a smart gas secondary network user platform, a smart gas secondary network service platform, a smart gas secondary network management platform, a smart gas secondary network sensor network platform, and a smart gas secondary network object platform. The smart gas secondary network user platform may include the gas user platform and the smart gas government supervision and management platform, the smart gas secondary network service platform may include the gas user service platform, the smart gas secondary network management platform may include the smart gas government supervision object platform, the smart gas secondary network sensor network platform may include the gas company sensor network platform, and the smart gas secondary network object platform may include the smart gas device object platform.

Based on the supervision system 100, a closed loop of information operation may be formed between various functional platforms, coordinated and regular operation, and realize the informatization and intelligence of the continuous monitoring of the smart gas underground pipeline corridor.

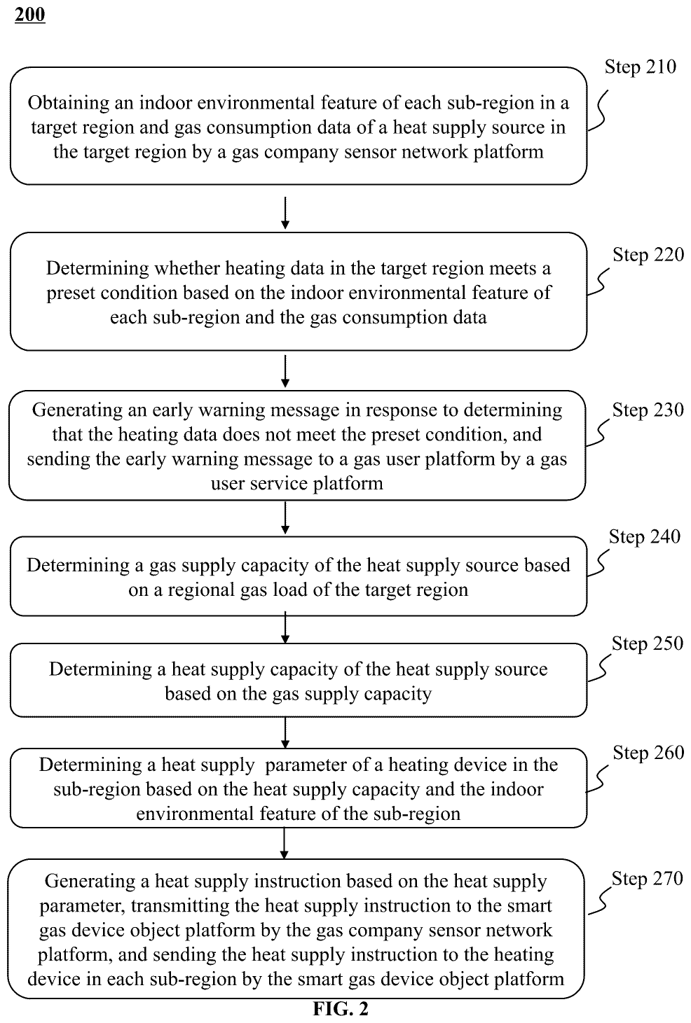

Detailed descriptions of the contents of the supervision system may be referred to relevant descriptions of FIG. 2 to FIG. 5.

FIG. 2 is a flow chart illustrating a method for centralized heating gas supervision based on a supervision platform according to some embodiments of the present disclosure; As shown in FIG. 2, a process 200 may include following steps. In some embodiments, the process 200 may be performed by a gas company management platform.

Step 210, obtaining an indoor environmental feature of each sub-region in a target region and gas consumption data of a heat supply source in the target region by a gas company sensor network platform.

The target region refers to a residential region with central heating, such as a neighborhood, an apartment, or the like. The sub-region refers to a separate indoor space of each resident in the target region.

The indoor environmental feature is a parameter that characterizes environment of an indoor space. In some embodiments, the indoor environmental feature may include an indoor temperature, an indoor humidity, and an indoor ventilation area, or the like.

In some embodiments, the gas company management platform may obtain a corresponding indoor environmental feature using a relevant sensor located indoors.

The heat supply source is a device used to provide heat in a heating system. The heat supply source may supply heat to a space inside a house via a heat supply pipeline. In some embodiments, the heat supply source may be a gas boiler for central heating.

The gas consumption data is data related to gas consumed by the heat supply source. In some embodiments, the gas consumption data may include gas consumption amount and gas utilization rate. The gas consumption amount may be represented by a volume of gas consumed per unit of time.

In some embodiments, the gas consumption data may be obtained via a sensor provided inside the heat supply source. For example, the gas consumption amount may be obtained through a gas flow meter of the heat supply source.

Step 220, determining whether heating data in the target region meets a preset condition based on the indoor environmental feature of each sub-region and the gas consumption data.

The heating data refers to data related to heat supply from the heat supply source to the target region, and the heating data may reflect an extent to which a current actual situation of centralized heating deviates from an ideal situation. In some embodiments, the heating data may include at least one of a temperature of the sub-region in the target region, operation data of a heat supply source associated with the target region, or an operation situation of a heating device in the target region.

The preset condition is a condition for determining whether current heating data meets a requirement. In some embodiments, the preset condition may include a minimum heating temperature that should be reached in each sub-region in the target region.

In some embodiments, the gas company management platform may, based on the gas consumption data of the heat supply source, determine the minimum heating temperature that should be reached in each sub-region; based on the indoor environmental feature of each sub-region and the minimum heating temperature, collect a count of sub-regions whose indoor temperatures are below the minimum heating temperature; at this time, the preset condition may include that the count of sub-regions whose indoor temperatures are lower than the minimum heating temperature is not greater than a preset count threshold, and if the count of sub-regions whose indoor temperatures are lower than the minimum heating temperature is greater than the preset count threshold, it is determined that the heating data does not meet the preset condition. The minimum heating temperature and the preset count threshold may be obtained based on historical data or a priori experience.

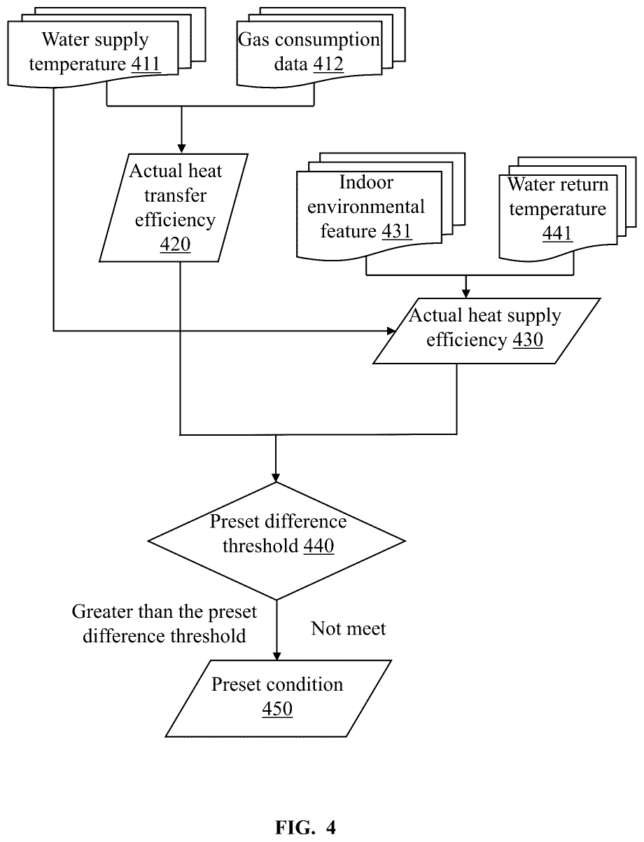

In some embodiments, the gas company management platform may also determine whether the heating data meets the preset condition based on a difference between an actual heat transfer efficiency and a standard heat transfer efficiency, and a difference between an actual heat supply efficiency and a standard heat supply efficiency in the heating system. More detailed instructions may be found in the relevant description in FIG. 4.

Step 230, generating an early warning message in response to determining that the heating data does not meet the preset condition.

The early warning message is used to alert a user that the current heating data does not meet a standard. In some embodiments, the early warning message may include at least one of currently indoor temperature failing to meet a standard, a problem with a heating system, or a problem with an indoor heating device. In some embodiments, the early warning message may also include other warnings related to the heating system, which may be determined based on an actual situation.

In some embodiments, when a count of sub-regions whose temperatures do not reach a standard heating temperature is greater than a preset count, the gas company management platform may generate the early warning message that there is a need to adjust the centralized heating system.

In some embodiments, when the difference between the actual heat transfer efficiency and the standard heat transfer efficiency is too large, the gas company management platform may generate an early warning message that the heat supply source is abnormal or a water supply pipeline is abnormal.

In some embodiments, when the difference between the actual heat supply efficiency and the standard heat supply efficiency is too large, the gas company management platform may generate an early warning message that the heating device is abnormal and prompt the user to check by himself or herself.

Detailed descriptions of the actual heat transfer efficiency, the standard heat transfer efficiency, the actual heat supply efficiency, and the standard heat supply efficiency may be found in FIG. 4 of the present disclosure.

In some embodiments, the gas company management platform may send the early warning message to the gas user platform via the gas user service platform.

Step 240, determining a gas supply capacity of the heat supply source based on a regional gas load of the target region.

The regional gas load is a gas consumption amount of gas devices other than the heat supply source in the target region. In some embodiments, the gas consumption amount of other gas devices may be determined by a gas meter at an inlet of the other gas devices to determine the regional gas load.

The gas supply capacity refers to the ability of a gas supply device to provide gas to the heat supply source. In some embodiments, the gas supply capacity may be expressed by a maximum gas supply rate.

In some embodiments, the gas supply capacity is negatively related to the regional gas load. Since the gas supply device needs to provide gas to the heat supply source and other gas devices, when a gas usage amount of other gas devices increases, the regional gas load becomes larger, an amount of gas available to the heat supply source decreases, and the maximum gas supply rate is smaller.

In some embodiments, the processor may determine the gas supply capacity in various ways. For example, the processor may determine a total gas supply capacity based on a gas flow valve at an outlet of the heat supply source. Then, by subtracting the regional gas load from the total gas supply capacity, a residual gas amount is determined as the gas supply capacity of the heat supply source.

Step 250, determining a heat supply capacity of the heat supply source based on the gas supply capacity.

The heat supply capacity is an ability of the heat supply source to supply heat by consuming gas. In some embodiments, the heat supply capacity may include a maximum heat supply rate of the heat supply source.

In some embodiments, the gas company management platform may calculate the heat supply capacity of the heat supply source by a preset formula based on the maximum gas supply rate corresponding to the gas supply capacity and a heat conversion efficiency of the heat supply source. The preset formula may be determined based on physical laws.

Step 260, determining a heat supply parameter of a heating device in the sub-region based on the heat supply capacity and the indoor environmental feature of the sub-region.

The heat supply parameter is a control parameter used to control the indoor heating device for centralized heating. The indoor heating device includes at least a radiator, an underfloor heating water pipe, or the like.

In some embodiments, the heat supply parameter may be represented by vectors.

In some embodiments, the heat supply parameter includes at least one of a water supply temperature and a water return temperature of the radiator and/or the underfloor heating water pipe. Exemplarily, the heat supply parameter may be [(radiator: 72° C., 61° C.; underfloor heating water pipe: 67° C., 53° C.)], indicating that a water supply temperature of the radiator is 72° C. and a water return water temperature is 61° C.; a water supply temperature of the underfloor heating water pipe is 67° C. and a water return temperature is 53° C.

In some embodiments, the gas company management platform may determine a current heat supply parameter by retrieving a first preset table based on a current heat supply capacity and the indoor environmental feature. The first preset table may be constructed based on a historical heat supply capacity, a historical indoor environmental feature, and historical heat supply parameters corresponding to the historical heat supply capacity and the historical indoor environmental feature. The historical heat supply parameter may be determined based on heat supply parameters that meet a condition in historical operation data of the heating system, and the condition may include the heat supply parameter that enables an indoor temperature of each sub-region to reach a standard heating temperature interval.

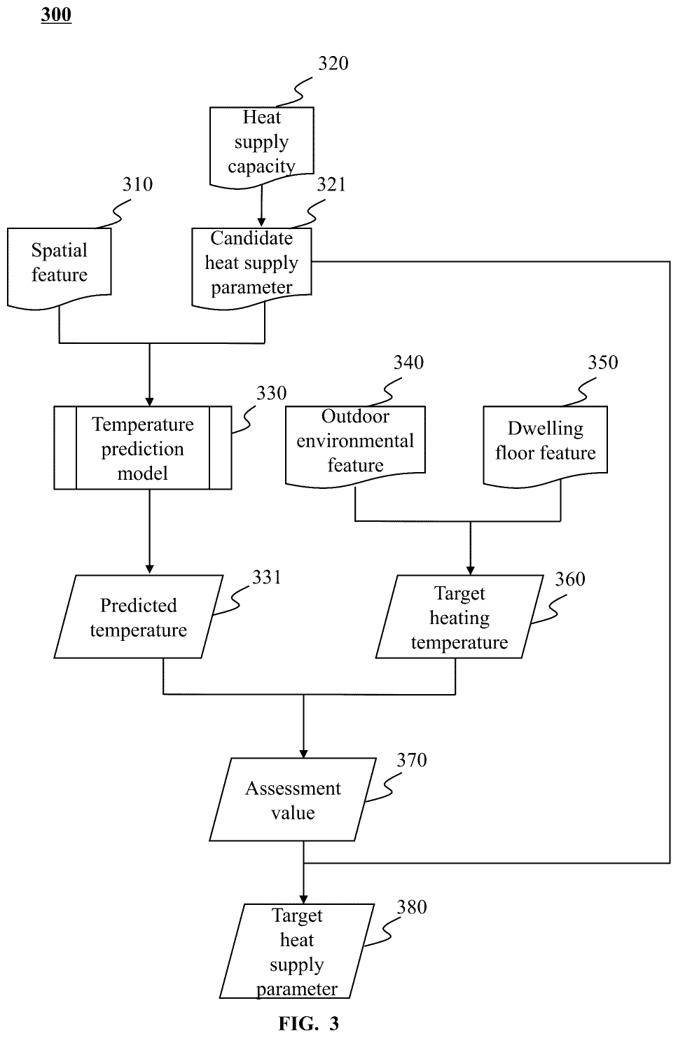

In some embodiments, the smart gas device object platform may also generate a candidate parameter set based on the heat supply capacity of the heat supply source; determine a predicted temperature of the sub-region at at least one future moment when heating based on a candidate heat supply parameter, and determine a target heat supply parameter by evaluating the candidate heat supply parameter based on a target heating temperature of the sub-region and the predicted temperature. A more detailed description may be found in FIG. 3 of the present disclosure and its related description.

Step 270, generating a heat supply instruction based on the heat supply parameter, transmitting the heat supply instruction to a smart gas device object platform by a gas company sensor network platform, and sending the heat supply instruction to the heating device in each sub-region by the smart gas device object platform.

The heat supply instruction refers to a regulation parameter for controlling heat supply from a heat supply source in each sub-region to an indoor environment, and by varying the heat supply parameter, a temperature of the indoor environment may be varied. In some embodiments, the heat supply parameter may include an outlet water temperature of a water supply pipeline, an outlet flow rate, or the like.

In some embodiments, the processor may generate the heat supply instruction based on the heat supply parameter.

In some embodiments of the present disclosure, by monitoring the indoor environmental feature and determining whether current centralized heating meets a standard, it may be ensured that the heating effect of the centralized heating can meet a heating requirement. When the heating requirement is not met, generating the heat supply instruction based on the heat supply parameter and adjusting parameters of the heat supply source allows for more accurate regulation, facilitates regulation of a gas company, and provides users in the sub-region with better heating effects.

FIG. 3 is a schematic diagram illustrating an exemplary fault prediction model according to some embodiments of the present disclosure. In some embodiments, a target heat supply parameter is determined by a gas company management platform.

In some embodiments, the gas company management platform may determine a target heating temperature 360 in a sub-region based on an outdoor environmental feature 340 and a dwelling floor feature 350 of the sub-region.

The outdoor environmental feature is a parameter that characterizes an outdoor environment. In some embodiments, the indoor environmental feature may include at least one of an outdoor temperature or an outdoor humidity. The outdoor environmental feature may be obtained by a sensor disposed outdoors.

The dwelling floor feature is a geographic location feature of a sub-region at which a user is located. In some embodiments, the dwelling floor feature may include a floor on which the sub-region is located, orientation information of the sub-region, or the like.

The target heating temperature is a heating temperature required to keep an indoor temperature of the sub-region in an appropriate temperature range.

The target heating temperature is correlated with the outdoor environmental feature and the dwelling floor feature. The lower the outdoor temperature in the outdoor environmental feature, and the higher the floor where the sub-region is located in the dwelling floor feature, the higher the target heating temperature corresponding to the sub-region.

In some embodiments, the gas company management platform may obtain the target heating temperature in a plurality of ways. Exemplarily, the gas company management platform may determine the target heating temperature by querying a second preset table based on the outdoor temperature, the indoor temperature, and the orientation information. The second preset table may include various values of the outdoor temperature, the indoor temperature, and the orientation information, or the like, and a preset correspondence of the target heating temperature. The second preset table may be constructed based on historical data.

In some embodiments, the gas company management platform may further obtain mobility data of the residents in the target region from a gas government safety supervision sensor network platform; based on the mobility data and historical heating data of each sub-region, predict a heating demand time of the residents of each sub-region in the target region, and determine a target heating temperature of each sub-region based on outdoor environmental feature, the dwelling floor feature, and the heating demand time.

The mobility data is data related to residents in the target region leaving the sub-region and returning to the sub-region. In some embodiments, the mobility data may include a time of leaving home and a time of returning home.

The heating demand time is a time when a user is located in the sub-region and needs centralized heating.

In some embodiments, the gas company management platform may determine the heating demand time of the residents of each sub-region in multiple ways. Exemplarily, the gas company management platform may obtain at least one piece of historical heating data in the sub-region, mark each piece of historical heating data, respectively, based on a home status of a resident corresponding to the historical heating data, determine a label corresponding to the historical heating data, the label characterizing whether the resident in the sub-region is at home when the historical heating data is adopted; construct a reference heating database based on at least one piece of historical heating data and a label corresponding to the at least one piece of historical heating data; based on current heating data in the sub-region, match a piece of historical heating data that is closest to the current heating data in the reference heating database, and determine a current home state of the resident in the sub-region based on the label corresponding to the historical heating data.

In some embodiments, in response to determining that the current home state of the resident in the sub-region is unoccupied, the gas company management platform may determine a predicted time of returning home of the resident in the sub-region based on historical mobility data of the resident in the sub-region by querying a historical mobility database.

For example, the gas company management platform may construct a reference mobility database based on the historical mobility data of the resident in the sub-region and a historical time of returning home corresponding to the historical mobility data. The historical mobility data may include a historical time of leaving home of the resident and historical gas usage data within a preset time before the departure. The gas company management platform may, based on the historical time of leaving home of the resident in the sub-region and the gas usage data within the preset time before the departure, perform a match in the reference mobility database, and determine a predicted time of returning home based on a historical time of returning home determined by the match.

In some embodiments, the mobility data may also include heating data for a period of time prior to the departure, and a manually set value for a heating device prior to the departure. At this time, the reference heating database may include the heating data for a period of time prior to the departure, the manual setting value for the heating device for a period of time prior to the departure, the historical heating data, and a label corresponding to the historical heating data. The gas company management platform may, based on heating data prior to the departure at a current moment, the manual setting value for the heating device prior to the departure, and current heating data, perform a match in the reference heating database, and determine a piece of historical heating data that is closest to the current heating data, and determine the home state of the resident in the sub-region based on the label corresponding to the historical heating data.

In some embodiments of the present disclosure, a time of returning home of the user may be predicted based on the manual setting value for the heating device as the user usually sets the heating device before leaving home. When the user is not home, and the heating device is not turned off, it is often the case that the user is leaving a residence for a short period of time, and when the user manually sets a power of the heating device to a lower value before leaving, it often means that the residence will not be inhabited for a longer period of time, which may be inferred that the user may not return home anytime soon, and at this time, it may be appropriate to reduce the indoor temperature to save energy and improve an efficiency utilization rate of centralized heating.

In some embodiments, the gas company management platform may determine a time after the predicted time of returning home as the heating demand time.

In some embodiments, the target heating temperature is also correlated with the heating demand time of the user. The closer the heating demand times of the residents in the sub-region, the higher the target heating temperature corresponding to the sub-region.

In some embodiments, the gas company management platform may determine the target heating temperature based on the outdoor environmental feature, the dwelling floor feature, and the heating demand time by performing a match in the reference database.

The gas company management platform may construct a to-be-matched vector based on the outdoor environmental feature, the dwelling floor feature, and the heating demand time. The gas company management platform may retrieve the vector database based on the to-be-matched vector, obtain a reference vector whose vector distance from the to-be-matched vector is less than a distance threshold, and determine a historical target heating temperature corresponding to the reference vector whose vector distance from the to-be-matched vector is less than the distance threshold as a currently-needed target heating temperature. The vector database is used to store a plurality of historical vectors and historical actual heating temperatures corresponding to the historical vectors. The historical vector is constructed based on historical environmental data, a historical dwelling floor feature, and a historical heating demand time. The historical actual heating temperature is a heating temperature in the historical heating data that is capable of meeting a heating demand.

In some embodiments of the present disclosure, determining the target heating temperature based on the outdoor environmental feature, the dwelling floor feature, and the heating demand time may fully take into account a height of a residence, a temperature difference between the indoors and outdoors, and other factors affecting the centralized heating to ensure that the target heating temperature may meet actual needs of users.

In some embodiments, the gas company management platform may generate a candidate heat supply parameter set based on a heat supply capacity 320 of a heat supply source.

The candidate heat supply parameter set refers to a parameter set consisting of a series of candidate heat supply parameters, and the candidate heat supply parameter set may include a candidate heat supply parameter 321 for a heating device in each sub-region.

In some embodiments, the gas company management platform may select a set of candidate heat supply parameters from the candidate heat supply parameter set, and determine the set of candidate heat supply parameters as a desired target heat supply parameter.

In some embodiments, the gas company management platform may determine a baseline value for the heat supply parameter. The baseline value is the most common and general parameter of a heating device under a normal operation condition. The baseline value may be represented by vectors. In the case of a radiator, for example, a baseline value may be [(Radiator: 80° C., 50° C.)], which means that a water supply temperature of the radiator is 80° C. and a water return temperature of the radiator is 50° C.

In some embodiments, the gas company management platform may generate a secondary candidate heat supply parameter set based on a baseline value for at least one heat supply parameter of a heating device in the target region and a randomized floating value. Exemplarily, the secondary candidate heat supply parameter set may be [sub-region 1 (radiator: 82°° C., 51° C.), sub-region 2 (radiator: 76°° C., 47° C.), sub-region 3 (radiator: 84° C., 54° C.)].

In some embodiments, the gas company management platform may filter generated secondary candidate heat supply parameter sets to remove secondary candidate heat supply parameter sets that do not meet a candidate condition. The candidate condition may include that the heat supply capacity of the heat supply source may meet a heat demand corresponding to the secondary candidate heat supply parameter set.

For example, based on the secondary candidate heat supply parameter set, the gas company management platform may calculate heat demands corresponding to different secondary candidate heat supply parameter sets through a common heat calculation manner, and determine whether a corresponding heat demand exceeds the heat supply capacity of the heat supply source, and determine a secondary candidate heat supply parameter whose heat demand is not greater than the heat supply capacity of the heat supply source as the candidate heat supply parameter set.

In some embodiments, the gas company management platform may determine a predicted temperature 331 of the sub-region at at least one future moment when heating based on the candidate heat supply parameter 321.

The predicted temperature is an indoor temperature at a future time point of a corresponding sub-region when heating based on the candidate heat supply parameter.

In some embodiments, the gas company management platform may determine the predicted temperature in a plurality of ways. For example, the gas company management platform may construct the to-be-matched vector based on the candidate heat supply parameter, the dwelling floor feature, and the outdoor environmental feature. The gas company management platform may retrieve in the vector database based on the to-be-matched vector to obtain a reference vector whose vector distance from the to-be-matched vector is less than a distance threshold, and determine a historical temperature corresponding to the reference vector whose vector distance is less than a distance threshold as a currently-needed predicted temperature. The vector database is used to store a plurality of historical vectors and historical temperatures corresponding to the historical vectors. The historical vector is constructed based on a historical candidate heat supply parameter, the historical dwelling floor feature, and the historical outdoor environmental feature.

In some embodiments, the gas company management platform may also determine the predicted temperature 331 of the sub-region at the at least one future moment based on a spatial feature 310 of the sub-region and the candidate heat supply parameter 321 through a temperature prediction model 330.

The temperature prediction model refers to a model for predicting an indoor temperature at a future time point. In some embodiments, the temperature prediction may be a machine-learning model, e.g., a Deep Neural Networks (DNN) model.

In some embodiments, inputs to the temperature prediction model include spatial feature 310 of the sub-region and the candidate heat supply parameter 321; and an output of the temperature prediction model includes the predicted temperature 331 of the sub-region at the at least one future moment.

The spatial feature is a parameter feature associated with a space within the sub-region. In some embodiments, the spatial feature may include a volume of an indoor space, a height of the indoor space, or the like.

In some embodiments, the temperature prediction model may be obtained by training an initial temperature prediction model based on first training samples and first training labels. In some embodiments, the first training sample may include at least one set of historical data, each set of historical data including a historical spatial feature of a sample sub-region at a first historical time point and a historical candidate heat supply parameter, and the first training label may be a historical actual temperature of the sample sub-region at a second historical time point. The first historical time point is earlier than the second historical time point.

During a training, the first training sample is input into the initial temperature prediction model, a loss function is constructed based on an output of the initial temperature prediction model and a label, and parameters of an initially determined model are iteratively update based on the loss function until the parameters meet a preset condition, when the training is completed, a trained temperature prediction model is obtained. The preset condition may include but is not limited to, the loss function converging, a training period reaching a threshold, or the like.

In some embodiments, an input to the temperature prediction model further includes a predicted heating scenario of the sub-region.

The predicted heating scenario is a scenario where a specific ventilation area in the sub-region is centrally heated at a future time. Exemplarily, the predicted heating scenario may include a predicted ventilation area corresponding to the sub-region.

In some embodiments, the gas company management platform may further determine the predicted temperature of the sub-region at the at least one future moment when heating based on the candidate heat supply parameter and the predicted heating scenario through the temperature prediction model. At this time, the input into the temperature prediction model includes the predicted heating scenario, the spatial feature of the sub-region, a candidate heat supply parameter corresponding to the sub-region in the candidate heat supply parameter set, and the output is a predicted temperature of the sub-region at the at least one future moment in the predicted heating scenario when heating based on the candidate heat supply parameter.

At this point, the first training sample also includes a historical heating scenario, and the historical heating scenario needs to be input into the initial temperature prediction model when training the model.

When the resident uses the heating device for heating, there may be different heating scenarios, e.g., windows being open, windows being closed, or windows being partially opened, which may result in differences in the ventilation area of the sub-region, thus producing different heating effects with a same candidate heat supply parameter. In some embodiments of the present disclosure, determining the predicted temperature of the sub-region by considering the influence of the predicted heating scenario on the heating effect in the sub-region can adapt to different scenarios and more accurately predict the temperature of the sub-region at a future moment, providing a more accurate data reference for determining the target heat supply parameter.

In some embodiments, the gas company management platform may determine the target heat supply parameter of the heating device in the sub-region based on the target heating temperature 360 of the sub-region and the predicted temperature 331 corresponding to the candidate heat supply parameter in a variety of ways.

In some embodiments, in response to determining that the predicted temperature corresponding to the candidate heat supply parameter is not less than the target heating temperature of the sub-region, the gas company management platform may determine the candidate heat supply parameter as the target heat supply parameter of the heating device in the sub-region.

In some embodiments, the gas company management platform may determine an assessment value 370 of the candidate heat supply parameter based on the target heating temperature 360 of the sub-region and the predicted temperature 331 corresponding to the candidate heat supply parameter; and in response to determining that the assessment value 370 meets with a target condition, determine the candidate heat supply parameter as a target heat supply parameter 380. The target condition may include an assessment value corresponding to the candidate heat supply parameter being the largest.

The assessment value of the candidate heat supply parameter is a rate value to score whether a current heat supply parameter is ideal. The higher the rate value, the more ideal the candidate heat supply parameter is.

In some embodiments, the assessment value may include a first assessment value and a second assessment value.

The first assessment value is a rate value used to reflect a heating efficiency and a living comfort level of the sub-region. The higher the first assessment value, the higher the heating efficiency and the higher the living comfort level of the sub-region.

In some embodiments, the gas company management platform may determine a temperature arrival length and a temperature duration length in the sub-region based on the target heating temperature of the sub-region and the predicted temperature corresponding to the candidate heat supply parameter, and determine the first assessment value of the candidate heat supply parameter based on the temperature arrival length and the temperature duration length.

In some embodiments, the first assessment value may be negatively correlated to a sum of temperature arrival lengths of the residents in the sub-region and positively correlated to a sum of temperature duration lengths of the residents in the sub-region. The temperature arrival length is a length of time experienced by the sub-region to reach a corresponding target heating temperature, and the temperature duration length is a length of time the sub-region is maintained at the target heating temperature.

In some embodiments, the gas company management platform may obtain the first assessment value by means of a formula (1).

$${θ}_{1} = \frac{{k}_{1}}{{t}_{1} + {t}_{2} + … + {t}_{n}} + {k}_{2} \times ( {T}_{1} + {T}_{2} + … + {T}_{n} ) \qquad ( 1 )$$

where, θ₁ denotes the first assessment value, k₁ and k₂ denote preset coefficients, t₁, t₂, tₙdenote temperature arrival lengths of a sub-region 1, a sub-region 2, . . . , a sub-region n, and T₁, T₂, Tₙ denote temperature duration lengths of the sub-region 1, the sub-region 2, . . . , and the sub-region n.

In some embodiments, a temperature arrival length and a temperature duration length of each sub-region under the candidate heat supply parameter may be determined in a variety of ways. For example, the lengths may be determined based on the predicted temperature of the sub-region at the at least one future moment under the candidate heat supply parameter. As another example, based on the predicted heating scenario, the predicted temperature of the sub-region at the at least one future moment is determined when the candidate heat supply parameter is used for heating.

In some embodiments, the gas company management platform may determine a heat supply parameter of a heating device of each resident in the sub-region based on a candidate heat supply parameter set with a largest first assessment value.

The second assessment value is a parameter reflecting an anomaly probability of a heating system when operating based on the candidate heat supply parameter. The higher the second assessment value is, the lower the anomaly probability of the heating system is.

In some embodiments, the gas company management platform may determine a second assessment value of the candidate heat supply parameter based on a first probability and a second probability corresponding to the candidate heat supply parameter.

In some embodiments, the second assessment value is negatively correlated with the first probability and the second probability. That is, the less the first probability and the less the second probability, the larger the second assessment value.

In some embodiments, the second assessment value may be obtained by means of a formula (2).

$${θ}_{2} = \frac{{k}_{3}}{{A}_{1}} + \frac{{k}_{4}}{{A}_{2}} \qquad ( 2 )$$

where, θ₂ denotes the second assessment value, k₃ and k₄ denote preset coefficients, A₁ denotes the first probability, and A₂ denotes the second probability.

In some embodiments, the gas company management platform may identify a candidate heat supply parameter set whose second assessment value is greater than a preset safety threshold and whose first assessment value is the largest as a target heat supply parameter for the sub-region.

In some embodiments, the preset safety threshold may be preset based on a priori experience.

In some embodiments, the first probability and the second probability may be predicted by a fault prediction model. An input to the fault prediction model is a heat supply structure diagram, and an output is a first probability and a second probability corresponding to each candidate heat supply parameter set. At this time, the heat supply structure diagram used as the input to the fault prediction model is similar in form to a heat supply structure diagram in FIG. 4, and a water supply temperature and a water return temperature in a node feature thereof are determined based on a temperature corresponding to the heating device of the sub-region in the candidate heat supply parameter.

Further description of the first probability, the second probability, the fault prediction model, and the heat supply structure diagram may be found in FIG. 4 and its related contents.

In some embodiments of the present disclosure, by obtaining the candidate heat supply parameter set in advance and judging a temperature change in the sub-region when different candidate heat supply parameter sets are adopted, and selecting the most suitable heat supply parameter based on a judgment condition, it is possible to ensure that an obtained heat supply parameter is suitable for heating needs of most users, thereby ensuring the reliability of the heating effect.

FIG. 4 is a schematic diagram illustrating determining whether heating data meets a preset condition according to some embodiments of the present disclosure. In some embodiments, determining whether the heating data meets the preset condition may be performed by a gas company management platform.

In some embodiments, the gas company management platform may determine an actual heat transfer efficiency 420 based on a water supply temperature 411 of a heating device in each sub-region at at least one time point and gas consumption data 412 of a heat supply source; based on an indoor environmental feature 431 of each sub-region at the at least one time point, and a water supply temperature 411 and a water return temperature 441 of the heating device at the at least one time point, calculate an actual heat supply efficiency 430, and based on a difference between the actual heat transfer efficiency and a standard heat transfer efficiency and a difference between the actual heat supply efficiency and a standard heat supply efficiency, determine whether or not the heating data meets the preset condition.

The water supply temperature 411 is a temperature of water at a water inlet of the heating device. For example, the water supply temperature of the heating device may be 50° C. In some embodiments, the gas company management platform may obtain the water supply temperature at the at least one time point by means of a temperature sensor disposed at the water inlet of the heating device. The at least one time point may be a preset time point based on actual needs, for example, obtaining the at least one time point every ten minutes.

The actual heat transfer efficiency 420 refers to a heat transfer efficiency of the heating device when it is actually operating. In some embodiments, the heat transfer efficiency may be used to characterize a loss degree of heat generated by the heat supply source as it is transferred to the water inlet of the heating device.

In some embodiments, the gas company management platform may calculate a theoretical temperature of water in the heat supply source based on the gas consumption data of the heat supply source and a calorific value of gas, and then, based on the theoretical temperature and the water supply temperature of the heating device in each sub-region at the at least one time point, calculate an actual heat transfer efficiency corresponding to the at least one time point.

The calorific value of gas refers to an amount of heat released from the complete combustion of a unit volume of gas. A description of the gas consumption data may be found in the detailed description of FIG. 2.

The indoor environmental feature is data characterizing an indoor environment of the sub-region. For example, the indoor environmental feature may include at least one of an actual indoor temperature, an actual indoor humidity, and an indoor ventilation area.

The water return temperature 441 is a temperature of water at a water outlet of the heating device. For example, the water return temperature of the heating device may be 30° C. In some embodiments, the gas company management platform may obtain the water return temperature at the at least one time point by a temperature sensor set at the water outlet of the heating device. The at least one time point may be the preset time point set based on actual demand.

The actual heat supply efficiency 430 is a ratio of an actual amount of heat produced while the heating device is operating to a theoretical amount of heat produced. In some embodiments, the actual heat supply efficiency may be used to characterize the heating effect of the heating device.

In some embodiments, the gas company management platform may obtain a theoretical indoor temperature based on the water supply temperature and the water return temperature of the heating device of each sub-region at the at least one time point; based on the theoretical temperature and an actual indoor temperature of each sub-region, calculate the actual heat supply efficiency. The actual indoor temperature may be determined based on an indoor environmental feature corresponding to the sub-region.

In some embodiments, the theoretical temperature may be obtained by reference to historical data or predicted based on a temperature prediction model. More information on the temperature prediction model can be referred to FIG. 3 and the related descriptions thereof.

In some embodiments, the actual heat supply efficiency and the actual heat transfer efficiency may also be calculated based on physical principles or relevant theoretical formulas.

In some embodiments, the smart gas management platform may calculate a first difference between the actual heat supply efficiency and the standard heat supply efficiency, and a second difference between the actual heat transfer efficiency and the standard heat transfer efficiency, based on the first difference and the second difference, determine whether the heating data meets the preset condition. For example, in response to determining that at least one of the first difference and the second difference is greater than a preset difference threshold 440, it is determined that heating data in a target region does not meet a preset condition 450.

In some embodiments, the preset difference threshold may be obtained based on historical data and/or actual experience.

In some embodiments, the smart gas management platform may generate an early warning message based on a judgment result of whether the heating data meets the preset condition and send the early warning message to a smart gas government supervision and management platform via a smart gas government supervision sensor network platform.

The standard heat transfer efficiency is a theoretical value of a heat transfer efficiency under an ideal condition. In some embodiments, the standard heat transfer efficiency may be determined based on historical experience.

The standard heat supply efficiency is a theoretical value of a heat supply efficiency under an ideal situation. In some embodiments, the standard heat supply efficiency may be determined based on historical experience.

In some embodiments of the present disclosure, by calculating the actual heat transfer efficiency and the actual heat supply efficiency based on actual data, a comparison is made between the actual heat transfer efficiency and the standard heat transfer efficiency, and between the actual heat supply efficiency and the standard heat supply efficiency. Through quantitative calculations, it is possible to intuitively determine whether the heating data meets the preset condition, which is conducive to timely supervising a working status of the heating device.

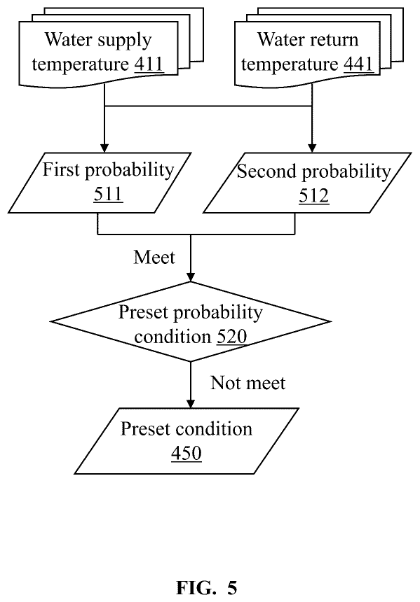

FIG. 5 is another schematic diagram illustrating determining whether heating data meets a preset condition according to some embodiments of the present disclosure. In some embodiments, determining whether the heating data meets the preset condition may be performed by a gas company management platform.

In some embodiments, the gas company management platform may predict, based on the water supply temperature 411 and the water return temperature 441 at at least one time point, a first probability 511 corresponding to a heat supply source and a heating pipeline in a sub-region, and a second probability 512 corresponding to a heating device; in response to determining that the first probability 511 and/or the second probability 512 meets a preset probability condition 520, determine that heating data in a target region does not meet the preset condition 450.

In some embodiments, the first probability 511 may be used to characterize a probability that the heat supply source and the heat supply pipelines in the sub-region are abnormal at at least one future time point. In some embodiments, the first probability may be expressed in a variety of ways, for example, as a percentage or a value between 0 and 1. The greater the first probability, the higher the risk that there is an anomaly in the heat supply source and the heat supply pipelines in the sub-region at the at least one future time point.

In some embodiments, the second probability 512 may be used to characterize a probability that the heating device in the sub-region is abnormal at the at least one future time point. In some embodiments, the second probability may be expressed in a variety of ways, for example, as a percentage or a value between 0 and 1. The higher the second probability, the higher the risk that there is an anomaly in the heating device in the sub-region at the at least one future time point.

In some embodiments, the gas company management platform may predict the first probability and the second probability in multiple ways. For example, the gas company management platform may determine the first probability and the second probability by looking up a preset table. The preset table may be statistically constructed based on historical data, including at least one set of reference water supply temperature and at least one set of reference water return temperature, and a reference first probability and a reference second probability corresponding to the set of reference water supply temperature and the set of reference water return temperature.

In some embodiments, the gas company management platform may also determine the first probability and the second probability through a fault prediction model.

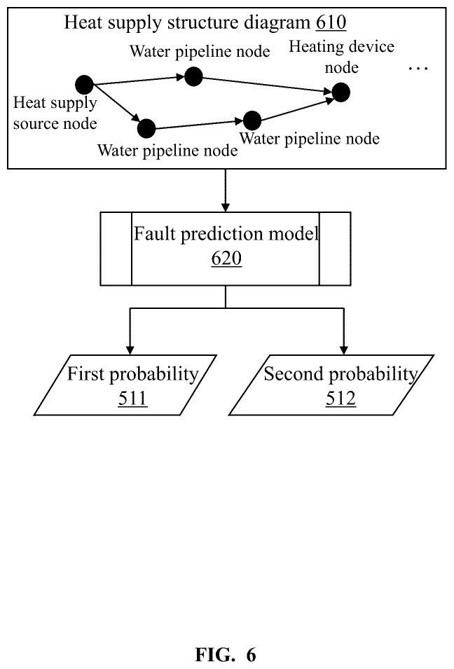

A more detailed description of the fault prediction model may be found in FIG. 6.

The preset probability condition is a condition used to determine whether the first probability and the second probability are within a reasonable range. In some embodiments, the preset probability condition may include a first probability threshold and a second probability threshold, and when the first probability is greater than the first probability threshold, and/or the second probability is greater than the second probability threshold, i.e., the first probability and/or the second probability meets the preset probability condition, it is determined that the heating data in the target region does not meet the preset condition.

In some embodiments, the preset probability condition may be determined based on historical data and/or experience.

In some embodiments, the first probability and the second probability are predicted by the water return temperature and the water supply temperature, which in turn determines whether the heating data meets the preset condition. Such set up facilitates management personnel to timely access to a usage situation of the heating device, facilitates the overhaul of a heating device with higher risk, and guarantees the safe usage of the heating device while enhancing the user experience at the same time.

FIG. 6 is a schematic diagram illustrating an exemplary fault prediction model according to some embodiments of the present disclosure.

In some embodiments, a gas company management platform may construct a heat supply structure diagram based on a water supply temperature and a water return temperature of a heating device in a sub-region at at least one time point, and based on the heat supply structure diagram, predict a first probability and a second probability by using the fault prediction model.

A heat supply structure diagram 610 is a mapping used to represent relationships between various devices and/or components in a heating system. In some embodiments, the heat supply structure diagram may include nodes and edges.

In some embodiments, the nodes may represent different devices and/or components in the heating system. For example, the nodes may include at least one of a heat supply source node, a water pipeline node, or a heating device node in the heating system. The heat supply source node is a node used to represent a heat supply source, and typically the heat supply source itself may serve as a node. The water pipeline node is a node configured to characterize a water pipeline, and may include at least one of a water supply pipeline and a water return pipeline, and typically each section of a pipeline may serve as a node. The heating device node is a node configured to characterize a heating device, and typically each heating device may serve as a node.

A node feature is information or parameters that indicate a feature of a node. In some embodiments, different nodes may have different node features.

For example, a node feature of the heat supply source node may include gas consumption data, and a water outlet temperature, where the water outlet temperature refers to a temperature of water at a water outlet of a heat supply source, and a detailed description of the gas consumption data can be found in FIG. 2. A node feature of the water pipeline node may include a length of a pipeline, temperatures of water in the pipeline collected by a sensor in the pipeline at a plurality of time points, and a water flow rate, and a node feature of the heating device node may include a type of heating device, and a water supply temperature and a water return temperature collected by a sensor in the heating device.

The type of heating device may be determined based on a physical object corresponding to the heating device node, for example, a type of the heating device node may include a first device node and a second device node, the first device node refers to a node corresponding to a radiator, and the second device node refers to a node corresponding to an underfloor heating pipeline, or the like. The detailed description of the water supply temperature and the water return temperature may be found in FIG. 4.

In some embodiments, the gas company management platform may determine the nodes and the node feature in multiple ways. For example, a node feature of a corresponding node may be obtained via a sensor set in the heating system.

In some embodiments, a node feature corresponding to the first device node further includes pressure data collected by a pressure sensor deployed at the first device node in a gas device object platform.

When the heating device is a radiator, a user may tend to cover the heating device with objects, which may bring potential risks, such as, uneven temperature distribution inside the heating device caused by uneven heat dissipation, which makes the heating device produce anomalies, and a second probability corresponding to the heating device will then increase.

In some embodiments of the present disclosure, by setting up the pressure sensor to collect the pressure data of the first device node, it may be possible to understand a pressure condition of a surface of each heating device in a timely manner, so as to provide data support for determining the second probability more accurately.

In some embodiments, the edges may be used to characterize connection relationships between different devices and/or components in the heating system. For example, edges of the heat supply structure diagram may be connecting pipelines between different devices and/or components.

In some embodiments, the edges of the heat supply structure diagram are directed edges, and a direction of the edge is a direction of flowing water in the connecting pipeline.

In some embodiments, an edge feature may include a water flow exchange rate between two connected nodes. The water flow exchange rate is a rate of flowing water at a junction of the two nodes.

In some embodiments, the gas company management platform may determine the rate of flowing water at the junction of the two nodes via a sensor disposed at a junction of the nodes in the heating system.

In some embodiments, the gas company management platform may determine the first probability 511 and the second probability 512 based on the heat supply structure diagram through a fault prediction model 620.

In some embodiments, the fault prediction model may be a machine-learning model. For example, the fault prediction model may be a Graph Neural Networks (GNN) model, or the like.

In some embodiments, an input to the fault prediction model may include the heat supply structure diagram, and outputs may include a first probability corresponding to the heat supply source node and/or a water pipeline node, and a second probability corresponding to the heating device node. A description of the first probability and the second probability may be found in the relevant description of FIG. 4.

In some embodiments, the fault prediction model may be obtained by training an initial fault prediction model based on a gradient descent or other possible means. For example, a training sample may be input into the initial fault prediction model, a loss function may be constructed based on an output of the initial fault prediction model and a training label, and parameters of the initial fault prediction model may be iteratively updated based on the loss function. When a preset condition is met, a training finishes. The preset condition may include the loss function converging, a count of iterations reaching a threshold, or the like.

In some embodiments, the training sample for training the fault prediction model may include a historical fault time point, at least one historical time interval prior to the historical fault time point, and a historical heat supply structure diagram corresponding to the at least one historical time interval. The historical heat supply structure diagram may be constructed based on historical sensing data corresponding to each time historical interval in the at least one historical time interval. The historical sensing data refers to historical data acquired by the sensor.

In some embodiments, there is a difference in duration between different time intervals in the at least one historical time interval, and a proportion of a count of samples of time intervals with different durations in the training sample to a total count of samples meets a preset percentage condition.

The preset percentage condition refers to a requirement for a proportion of a total count of samples with different durations in the training sample. In some embodiments, the preset percentage condition may include a preset proportion, the preset proportion characterizing a proportion of time interval samples with different durations to the total count of samples, and a sum of proportions of each time interval sample to the total count of samples is 100%. For example, if there are five different time interval samples with different durations in the training sample, then the preset proportion may be 20%: 20%: 20%: 20%: 20%. In some embodiments, the preset proportion may also be other values, which may be set according to the actual needs.

In some embodiments, the training label may be determined based on a length of each historical time interval, and a time interval between each historical time interval and the historical fault time point.

The historical fault time point is a time node when a fault in the historical heat supply source, the water supply pipeline, and/or the heating device has occurred. In some embodiments, the historical time interval includes the historical fault time point.

In some embodiments, the gas company management platform may determine at least one historical time interval based on the historical fault time point and a preset time interval. The preset time interval may include at least one time period determined based on historical experience and/or actual demand. For example, the preset time interval may include 1 hour, 6hours, 1 day, etc., before a historical fault event. The gas company management platform may determine three historical time intervals including a historical time interval A (1 hour before the historical fault event), a historical time interval B (6 hours before the historical fault event), and a historical time interval C (1 day before the historical fault event) based on the historical fault time point and the preset time interval.

In some embodiments, the gas company management platform may determine a label corresponding to each sample heat supply structure diagram based on a length of a time interval corresponding to each historical time interval and a time interval between the historical time interval and the historical fault time interval. In the case of the historical time interval A, for example, a value of a label corresponding to the historical time interval A is positively correlated to a length of a time interval of the historical time interval A, and is negatively correlated to a time interval between the historical time interval A and the historical fault time point. A maximum value of the label is 1.

In some embodiments of the present disclosure, by constraining the proportion of time intervals with different durations, samples of various time scales in sample data are uniformly distributed, which enhances the robustness and ubiquity of the model, and when setting the label, the influence of samples with different time scales is quantified to reduce the influence of data with longer time intervals and shorter duration on results, which is conducive for the model to more accurately predict a fault condition.

In some embodiments of the present disclosure, constructing the heat supply structure diagram to quantify individual devices and structures in the heating system, and then using the fault prediction model to predict structural nodes where faults are likely to occur helps to improve the identification of a failed device and prevent risks promptly to ensure a safe operation of the heating system.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure, such as “an embodiment”, “one embodiment”, and/or “some embodiments” means a feature, structure, or characteristic associated with at least one embodiment of the present disclosure. Accordingly, it should be emphasized and noted that “an embodiment” or “one embodiment” or “an alternative embodiment” in different places in the present disclosure do not necessarily refer to the same embodiment. In addition, certain features, structures, or characteristics of one or more embodiments of the present disclosure may be suitably combined.

In addition, unless expressly stated in the claims, the order of the processing elements and sequences, the use of numerical letters, or the use of other names as described herein are not intended to qualify the order of the processes and methods of the present disclosure. While some embodiments of the invention that are currently considered useful are discussed in the foregoing disclosure by way of various examples, it should be appreciated that such details serve only illustrative purposes, and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the disclosure of the present disclosure, and thereby aid in the understanding of one or more embodiments of the invention, the foregoing descriptions of embodiments of the present disclosure sometimes group multiple features together in a single embodiment, accompanying drawings, or in a description thereof. However, this method of disclosure does not imply that more features are required for the objects of the present disclosure than are mentioned in the claims. Rather, claimed subject matter may lie in less than all features of a single foregoing disclosed embodiment.

Some embodiments use numbers describing the number of components, attributes, and it should be understood that such numbers used in the description of the embodiments are modified in some examples by the modifiers “about”, “approximately”, or “substantially”. Unless otherwise noted, the terms “about,” “approximately,” or “substantially” indicates that a ±20% variation in the stated number is allowed. Correspondingly, in some embodiments, the numerical parameters used in the present disclosure and claims are approximations, which may change depending on the desired characteristics of individual embodiments. In some embodiments, the numerical parameters should take into account the specified number of valid digits and employ general place-keeping. While the numerical domains and parameters used to confirm the breadth of their ranges in some embodiments of the present disclosure are approximations, in specific embodiments, such values are set to be as precise as possible within a feasible range.

For each of the patents, patent applications, patent application disclosures, and other materials cited in the present disclosure, such as articles, books, specification sheets, publications, documents, etc., the entire contents of these patents, patent applications, disclosures, and other materials are hereby incorporated by reference into the present disclosure. Application history documents that are inconsistent with or conflict with the contents of the present disclosure are excluded, as are documents (currently or hereafter appended to the present disclosure) that limit the broadest scope of the claims of the present disclosure. It should be noted that to the extent that there is an inconsistency or conflict between the descriptions, definitions, and/or use of terms in the materials appurtenant to the present disclosure and those set forth herein, the descriptions, definitions and/or use of terms in the present disclosure shall control use.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A method for centralized heating gas supervision based on a supervision platform, wherein the method is executed by a gas company management platform of an Internet of Things (IoT) system for centralized heating gas supervision based on a supervision platform, comprising:
obtaining an indoor environmental feature of each sub-region in a target region and gas consumption data of a heat supply source in the target region by a gas company sensor network platform, the indoor environmental feature and the gas consumption data being collected by a smart gas device object platform;
determining whether heating data in the target region meets a preset condition based on the indoor environmental feature of each sub-region and the gas consumption data;
generating an early warning message in response to determining that the heating data does not meet the preset condition, and sending the early warning message to a gas user platform by a gas user service platform; and
determining a gas supply capacity of the heat supply source based on a regional gas load of the target region;
determining a heat supply capacity of the heat supply source based on the gas supply capacity;
determining a heat supply parameter of a heating device in the sub-region based on the heat supply capacity and the indoor environmental feature of the sub-region; and
generating a heat supply instruction based on the heat supply parameter, transmitting the heat supply instruction to the smart gas device object platform by the gas company sensor network platform, and sending the heat supply instruction to the heating device in each sub-region by the smart gas device object platform.

2. The method of claim 1, wherein the determining a heat supply parameter of a heating device in the sub-region based on the heat supply capacity and the indoor environmental feature of the sub-region includes:
determining a target heating temperature of the sub-region based on an outdoor environmental feature and a dwelling floor feature of the sub-region;
generating a candidate parameter set based on the heat supply capacity of the heat supply source, the candidate parameter set including a candidate heat supply parameter of the heating device in each sub-region;
determining a predicted temperature of the sub-region at at least one future moment when heating based on the candidate heat supply parameter; and
determining a target heat supply parameter of the heating device in the sub-region based on the target heating temperature and the predicted temperature.

3. The method of claim 2, wherein the determining a predicted temperature of the sub-region at at least one future moment when heating based on the candidate heat supply parameter includes:
determining the predicted temperature of the sub-region at the at least one future moment based on a spatial feature of the sub-region and the candidate heat supply parameter using a temperature prediction model, the temperature prediction model being a machine-learning model.

4. The method of claim 3, wherein an input of the temperature prediction model includes a predicted heating scenario of the sub-region; and
the method further comprises:
determining the predicted temperature of the sub-region at the at least one future moment when heating based on the candidate heat supply parameter based on the predicted heating scenario using the temperature prediction model.

5. The method of claim 2, wherein the determining a target heating temperature of the sub-region based on an outdoor environmental feature and a dwelling floor feature of the sub-region includes:
obtaining mobility data of residents in the target region from a gas government safety supervision sensor network platform;
predicting a heating demand time of residents of each sub-region in the target region based on the mobility data and historical heating data of each sub-region; and
determining the target heating temperature of the sub-region based on the outdoor environmental feature, the dwelling floor feature, and the heating demand time.

6. The method of claim 1, wherein the determining whether heating data in the target region meets a preset condition based on the indoor environmental feature of each sub-region and the gas consumption data includes:
determining an actual heat transfer efficiency based on a water supply temperature of the heating device in each sub-region at at least one time point and the gas consumption data of the heat supply source;
calculating an actual heat supply efficiency based on an indoor environmental feature of each sub-region at the at least one time point, and the water supply temperature and a water return temperature of the heating device at the at least one time point; and
determining whether the heating data in the target region meets the preset condition based on a difference between the actual heat transfer efficiency and a standard heat transfer efficiency, and a difference between the actual heat supply efficiency and a standard heat supply efficiency.

7. The method of claim 6, wherein the determining whether heating data in the target region meets a preset condition based on the indoor environmental feature of each sub-region and the gas consumption data further includes:
predicting a first probability corresponding to the heat supply source and heat supply pipelines and a second probability corresponding to the heating device in the sub-region based on the water supply temperature and the water return temperature at the at least one time point;
the first probability characterizing an anomaly probability of the heat supply source and the heat supply pipelines in the sub-region at at least one future time point;
the second probability characterizing an anomaly probability of the heating device in the sub-region at the at least one future time point; and
in response to determining that at least one of the first probability or the second probability meets a preset probability condition, determining that the heating data in the target region does not meet the preset condition.

8. The method of claim 7, wherein the predicting a first probability corresponding to the heat supply source and heat supply pipelines and a second probability corresponding to the heating device in the sub-region based on the water supply temperature and the water return temperature at the at least one time point includes:
constructing a heat supply structure diagram based on the water supply temperature and the water return temperature of the heating device in the sub-region at the at least one time point; wherein
the heat supply structure diagram includes nodes and edges;
the nodes characterize devices in a heating system, including a heat supply source node, a water pipeline node, and a heating device node, and the heating device node including a first device node and a second device node; and
the edges characterize connecting pipelines in the heating system, the connecting pipelines being configured to connect the devices in the heating system, the edges being oriented, and an orientation direction of the edges is a direction of flowing water in the connecting pipelines;
predicting the first probability and the second probability based on the heat supply structure diagram using a fault prediction model, the fault model being a machine-learning model.

9. The method of claim 8, wherein a node feature corresponding to the nodes includes pressure data captured by a pressure sensor deployed on the first device node.

10. The method of claim 8, wherein the fault prediction model is obtained by training an initial fault prediction model;
a training sample includes a historical fault time point, at least one historical time interval prior to the historical fault time point, a historical heat supply structure diagram corresponding to the at least one historical time interval, the historical heat supply structure diagram being constructed based on historical sensing data corresponding to each of the at least one historical time interval; and
a training label is determined based on a length of each of the at least one historical time interval and a time interval between each of the at least one historical time interval and the historical fault time point; wherein there are differences in duration between different time intervals in the at least one historical time interval, and a proportion of training samples of different durations to all training samples meets a pre-determined proportion condition.

11. An Internet of Things (IoT) system for centralized heating gas supervision based on a supervision platform, wherein the IoT system includes a smart gas government supervision and management platform, a smart gas government supervision sensor network platform, a smart gas government supervision object platform, a gas company sensor network platform, a smart gas device object platform, a gas user platform, and a gas user service platform; wherein
the smart gas government supervision object platform includes a gas company management platform, the gas company management platform is configured to:
obtain an indoor environmental feature of each sub-region in a target region and gas consumption data of a heat supply source in the target region by the gas company sensor network platform, the indoor environmental feature and the gas consumption data being collected by the smart gas device object platform;
determine whether heating data in the target region meets a preset condition based on the indoor environmental feature of each sub-region and the gas consumption data;
generate an early warning message in response to determining that the heating data does not meet the preset condition, and sending the early warning message to the gas user platform by the gas user service platform; and,
determine a gas supply capacity of the heat supply source based on a regional gas load of the target region; and
determine a heat supply capacity of the heat supply source based on the gas supply capacity;
determine a heat supply parameter of a heating device in the sub-region based on the heat supply capacity and the indoor environmental feature of the sub-region; and
generate a heat supply instruction based on the heat supply parameter, transmit the heat supply instruction to the smart gas device object platform by the gas company sensor network platform, and send the heat supply instruction to the heating device in each sub-region by the smart gas device object platform.

12. The IoT system of claim 11, wherein the gas company management platform is further configured to:
determine a target heating temperature of the sub-region based on an outdoor environmental feature and a dwelling floor feature of the sub-region;
generate a candidate parameter set based on the heat supply capacity of the heat supply source, the candidate parameter set including a candidate heat supply parameter of the heating device in each sub-region;
determine a predicted temperature of the sub-region at at least one future moment when heating based on the candidate heat supply parameter; and
determine a target heat supply parameter of the heating device in the sub-region based on the target heating temperature and the predicted temperature.

13. The IoT system of claim 12, wherein the gas company management platform is further configured to:
determine the predicted temperature of the sub-region at the at least one future moment based on a spatial feature of the sub-region and the candidate heat supply parameter using a temperature prediction model, the temperature prediction model being a machine-learning model.

14. The IoT system of claim 13, wherein an input of the temperature prediction model includes a predicted heating scenario of the sub-region; and
the gas company management platform is further configured to:
determine the predicted temperature of the sub-region at the at least one future moment when heating based on the candidate heat supply parameter based on the predicted heating scenario using the temperature prediction model.

15. The IoT system of claim 12, wherein the gas company management platform is further configured to:
obtain mobility data of residents in the target region from the gas government safety supervision sensor network platform;
predict a heating demand time of residents in each sub-region in the target region based on the mobility data and historical heating data of each sub-region; and
determine the target heating temperature of the sub-region based on the outdoor environmental feature, the dwelling floor feature, and the heating demand time.

16. The IoT system of claim 11, wherein the gas company management platform is further configured to:
determine an actual heat transfer efficiency based on a water supply temperature of the heating device in each sub-region at at least one time point and the gas consumption data of the heat supply source;
calculate an actual heat supply efficiency based on an indoor environmental feature of each sub-region at the at least one time point, and the water supply temperature and a water return temperature of the heating device at the at least one time point; and
determine whether the heating data in the target region meets the preset condition based on a difference between the actual heat transfer efficiency and a standard heat transfer efficiency and a difference between the actual heat supply efficiency and a standard heat supply efficiency.

17. The IoT system of claim 16, wherein the gas company management platform is further configured to:
predict a first probability corresponding to the heat supply source and heat supply pipelines and a second probability corresponding to the heating device in the sub-region based on the water supply temperature and the water return temperature at the at least one time point;
the first probability characterizing an anomaly probability of the heat supply source and the heat supply pipelines in the sub-region at at least one future time point;
the second probability characterizing an anomaly probability of the heating device in the sub-region at the at least one future time point; and
in response to determining that at least one of the first probability or the second probability meets a preset probability condition, determining that the heating data in the target region does not meet the preset condition.

18. The IoT system of claim 17, wherein the gas company management platform is further configured to:
construct a heat supply structure diagram based on the water supply temperature and the water return temperature of the heating device in the sub-region at the at least one time point; wherein
the heat supply structure diagram includes nodes and edges;
the nodes characterize devices in a heating system, including a heat supply source node, a water pipeline node, and a heating device node, and the heating device node including a first device node and a second device node;
the edges characterize connecting pipelines in the heating system, the connecting pipelines being configured to connect the devices in the heating system, the edges being oriented, and an orientation direction of the edges is a direction of flowing water in the connecting pipelines;
predict the first probability and the second probability based on the heat supply structure diagram using a fault prediction model, the fault model being a machine-learning model.

19. The IoT system of claim 18, wherein a node feature corresponding to the nodes includes pressure data captured by a pressure sensor deployed on the first device node.

20. The IoT system of claim 18, wherein the fault prediction model is obtained by training an initial fault prediction model;
a training sample includes a historical fault time point, at least one historical time interval prior to the historical fault time point, a historical heat supply structure diagram corresponding to the at least one historical time interval, the historical heat supply structure diagram being constructed based on historical sensing data corresponding to each of the at least one historical time interval; and
a training label is determined based on a length of each of the at least one historical time interval and a time interval between each of the at least one historical time interval and the historical fault time point; wherein there are differences in duration between different time intervals in the at least one historical time interval, and a proportion of training samples of different durations to all training samples meets a preset proportion condition.
